(19) United States
(12) Patent Application Publication
(10) Pub. No.: US 2024/0208864 A1
(43) Pub. Date: Jun. 27, 2024

(54) HYBRID AGGREGATE

(71) Applicant: CRDC Global Limited, Cork (IE)

(72) Inventor: Donald THOMSON, Roble de Santa Barbara (CR)

(21) Appl. No.: 18/556,024

(22) PCT Filed: Apr. 22, 2022
(86) PCT No.: PCT/EP2022/060750

§ 371 Date: Oct. 18, 2023

Related U.S. Application Data
(60) Provisional application No. 63/178,430, filed on Apr. 22, 2021.
(60) Provisional application No. 63/332,890, filed on Apr. 20, 2022.

(51) Int. Cl. C04B 20/04; C04B 18/20; C04B 20/02; C04B 20/10

(52) U.S. Cl. CPC C04B 20/04; C04B 18/20; C04B 20/026; C04B 20/1055

(57) ABSTRACT

Systems and methods are provided for making a hybrid aggregate from comingled waste plastics. A supply of granulated mixed waste plastic is treated with a preconditioning agent to improve sanitation and extruded to form an extruded product including waste plastic material. The extruded product is granulated to form a preconditioned resin aggregate and the granules are battered with cement powder or slurry. The battered preconditioned aggregate passes through a reactor to interact the cement powder with flue gases to form the hybrid aggregate with a limestone casing or layer around the preconditioned resin aggregate. The aggregate may also be reinforced with nanoparticles that capture and sequester carbon dioxide in the limestone layer.

### BACKGROUND

### Technical Field

This disclosure generally relates to aggregate particles, and is particularly, but not exclusively, applicable to compositions for use in the building industry or related industries.

### Description of the Related Art

Cementitious building and paving products are well known and are commonly made up of aggregate material and a cementitious or similar type binder and may include such articles as bricks, concrete, paving stones, roofing tiles, blocks, decorative articles, and the like. Known aggregate materials include gravel, crushed stone, sand, slag, and recycled concrete, among others. An undesirable feature which may be associated with such cementitious products is their high density.

In response, lightweight aggregates have been developed and increasingly applied throughout various industries. Together with cement and water, lightweight aggregates are used to prepare lightweight aggregate concrete. Lightweight aggregate concrete is a comparatively low density material that is finding increasing use in building construction and can confer engineering benefits. Lightweight aggregates currently available include manufactured materials such as sintered fly-ash, expanded clay, expanded shale, and foamed slag, as well as naturally occurring geological materials such as scoria and pumice. However, both known high density and lightweight aggregates suffer from a variety of deficiencies or drawbacks.

For example, production of known aggregates has a negative impact on the environment through greenhouse gas emissions. Further, collection of natural aggregates such as sand and gravel can erode riverbeds and have a devastating effect on water supply in certain areas.

Furthermore, only a small percentage of the plastics materials that are set aside for recycling are in fact recycled due to the time and cost of sorting the plastics into their differing types and washing the plastic before each type of plastic can be processed further. As a result, a large percentage of such plastic materials may be placed in landfills, incinerated, or leaked into the environment.

Plastics are one of the fastest growing municipal solid waste components, and there is increasing public demand for recycling. However, plastics are exceedingly difficult to recycle efficiently with available technology. For example, much of the plastic material in municipal wastes is multi-layered, heavily pigmented, contaminated and difficult to sort. The need to separate the various plastic types makes recycling of plastics technically difficult and expensive. Traditional recycling is therefore capable of dealing with just a small portion of the total volume of waste plastic generated by society.

Carbon capture and utilization is also becoming increasingly important within certain industries as greenhouse gas emissions and global warming continue to rise. While some types of concrete may continue to absorb carbon dioxide very gradually over time via a reaction with the composition of the concrete and carbon dioxide in the air, the reaction rate and carbon capture are not significant enough to produce a meaningful difference in the amount of carbon dioxide in the atmosphere.

Due to the issues surrounding the recycling of plastics, experiments have been conducted to use plastics in concrete. However, known methods of adapting plastic for use in concrete are only able to process specific types of plastic and do not incorporate all types of plastic waste, which limits the environmental impact of such methods. The acceptable types of plastic are also sorted and cleaned, which increases the costs associated with using plastic in concrete relative to other available aggregates. Further, known methods for incorporating plastic into concrete do not consider or address carbon capture are often a net negative with respect to greenhouse gas emissions due to the relatively small amount, if any, of carbon dioxide absorbed by the concrete relative to the carbon footprint of manufacturing concrete.

### BRIEF SUMMARY

Embodiments described herein provide a lightweight aggregate made in part of mixed plastic waste material, including “tragic” plastic, namely those plastics that have zero value from a traditional recycling perspective. Other embodiments described herein provide a mixed waste plastic feedstock for forming such aggregate. Advantageously, the aggregate may enable the production of lightweight construction products, such as lightweight construction blocks, while simultaneously removing waste plastics from the waste stream, which may otherwise end up in landfills or littering the environment. Such aggregate may be referred to herein as preconditioned absorptive resin aggregate, or PARA™, for short. Such aggregate may also be referred to as preconditioned resin aggregate, or PRA™, for short. Advantageously, embodiments provide for converting commingled plastic waste that has little to no current value into an environmentally and visually benign aggregate that can have multiple applications as a safe and inert, easily transportable, feedstock for multiple applications in various industry sectors, such as, for example, construction, agricultural, road building, and waste to fuel applications.

Embodiments also include additional processing of the preconditioned absorptive resin aggregate or preconditioned resin aggregate to form a calcium carbonate or limestone layer on an outer surface of the aggregate. Carbon dioxide from an exhaust source is captured and entrained in the limestone layer to advantageously reduce greenhouse gas emissions during formation of the aggregate. The calcium carbonate layer also improves the characteristics or qualities of the aggregate for use across various industries with a visually benign design due to the natural stone outer layer. Such aggregate may also be referred to as a hybrid aggregate that is made from both the plastic and emissions waste streams.

As an example, one embodiment of a method of making a lightweight aggregate may be summarized as including: obtaining a supply of granulated mixed plastic waste treated with a preconditioning agent to improve sanitation of the granulated mixed plastic waste; extruding the granulated mixed plastic waste to form an extruded product including waste plastic material; processing the extruded product to form an aggregate in which the waste plastic material is exposed at exterior surfaces thereof; battering the aggregate with cement powder to form a preconditioned aggregate; and passing the preconditioned aggregate through a reactor to interact the cement powder with flue gases in the reactor and form a hybrid aggregate with a calcium carbonate layer on the waste plastic material.

The battering the aggregate may include battering the aggregate with nanofiber impregnated cement paste instead of the cement powder, in an embodiment, and passing the battered aggregate through the reactor to form a fiber reinforced hybrid aggregate.

The supply of granulated mixed plastic waste includes a variety of plastic materials including at least one of high density polyethylene, polypropylene, PVC, ABS, polyurethane, polyamide, and PET. In some embodiments, the supply of granulated mixed plastic waste includes non-plastic material. The method further includes, after passing the preconditioned aggregate through the reactor, washing the hybrid aggregate in a calcium hydroxide bath and after washing the hybrid aggregate, drying the hybrid aggregate. The method may further include, before extruding the granulated mixed plastic waste, batching the preconditioned granulated mixed waste plastic by density.

The preconditioning agent is at least one of calcium hydroxide and ash. The supply of granulated mixed plastic waste treated by the preconditioning agent includes at least about 50% waste plastic material by weight. Further, passing the preconditioned aggregate through the reactor includes capturing carbon dioxide from the flue gases in the calcium carbonate layer and capturing carbon dioxide includes capturing carbon dioxide in an amount up to 50% by weight of the hybrid aggregate.

The method may further include, after obtaining the supply of granulated mixed plastic, mixing the supply of granulated mixed plastic waste treated with the preconditioning agent with one or more additives to form a plastic waste mixture. The one or more additives includes at least one of an essence, a fire retardant, pozzolans, and an anti-bacterial agent. extruding the granulated mixed plastic waste includes hot extruding at a processing temperature between about 165° C. and about 230° C.

Processing the extruded product to form the aggregate includes crushing and screening the extruded product to meet industry standard sizing requirements for aggregate, in some embodiments. Further, processing the extruded product to form the aggregate includes forming the aggregate to include fibrous extensions.

One embodiment of a device may be summarized as including: an aggregate including granulated mixed plastic waste treated with a preconditioning agent having waste plastic material exposed at exterior surfaces thereof; and a calcium carbonate layer on the aggregate, the calcium carbonate layer disposed on the waste plastic material exposed at exterior surfaces of the aggregate, wherein the calcium carbonate layer includes captured carbon dioxide. The device may further include nanofibers in the calcium carbonate layer in one or more embodiments.

The granulated mixed plastic waste includes a variety of plastic materials including at least one of high density polyethylene, polypropylene, PVC, ABS, polyurethane, polyamide, and PET. The granulated mixed plastic waste includes non-plastic material, in one or more embodiments. The preconditioning agent is at least one of calcium hydroxide and ash. An additive can be applied to the granulated mixed plastic waste, wherein the additive includes at least one of an essence, a fire retardant, pozzolans, and an anti-bacterial agent. The present disclosure further includes a concrete product including the device, wherein the concrete product may be any one of the products described herein.

### BRIEF DESCRIPTION OF THE SEVERAL VIEWS OF THE DRAWINGS

FIG. 1 shows an example embodiment of an aggregate production facility together with a process flow diagram illustrating aspects of the methods of making preconditioned resin aggregate disclosed herein.

FIGS. 2A and 2B show a process flow diagram illustrating aspects of methods of forming a concrete product with preconditioned resin aggregate made according to embodiments of the present disclosure.

FIGS. 3A and 3B provide enlarged images of an example preconditioned resin aggregate particle prepared in accordance with embodiments of the methods of making preconditioned resin aggregate disclosed herein.

FIG. 4 shows an example embodiment of an aggregate production facility illustrating aspects of one or more methods of making a hybrid aggregate disclosed herein.

FIG. 5 shows a process flow diagram illustrating aspects of methods of forming the hybrid aggregate from preconditioned resin aggregate made according to embodiments of the present disclosure.

FIG. 6 is an enlarged image of an example hybrid aggregate prepared in accordance with embodiments of the methods of making hybrid aggregate disclosed herein.

FIGS. 7A and 7B are enlarged images of an example fiber-reinforced hybrid aggregate prepared in accordance with embodiments of the methods of making fiber-reinforced hybrid aggregate disclosed herein.

FIG. 8 is a schematic illustration of processing machinery for forming fiber-reinforced hybrid aggregate in accordance with embodiments of the methods of making fiber-reinforced hybrid aggregate disclosed herein.

FIG. 9 is a side-by-side photograph of an air entrainment gauge demonstrating test results from the combination of fiber-reinforced hybrid aggregate with cement in accordance with the embodiments disclosed herein.

### DETAILED DESCRIPTION

In the following description, certain specific details are set forth in order to provide a thorough understanding of various disclosed embodiments. However, one of ordinary skill in the relevant art will recognize that embodiments may be practiced without one or more of these specific details. In other instances, well-known systems and processes associated with making aggregates or products comprising aggregates may not be shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

Embodiments described herein provide a lightweight aggregate made in part of mixed plastic waste material, including “tragic” plastic, namely those plastics that have zero value from a traditional recycling perspective. Other embodiments described herein provide a mixed waste plastic feedstock for forming such aggregate. Advantageously, the aggregate may enable the production of lightweight construction products, such as lightweight construction blocks, while simultaneously removing waste plastics from the waste stream, which may otherwise end up in landfills or littering the environment. Such aggregate may be referred to herein as preconditioned absorptive resin aggregate, or PARA™, for short. Such aggregate may also be referred to as preconditioned resin aggregate, or PRA™, for short. Advantageously, embodiments provide for converting commingled plastic waste that has little to no current value into an environmentally and visually benign aggregate that can have multiple applications as a safe and inert, easily transportable, feedstock for multiple applications in various industry sectors, such as, for example, construction, agricultural, road building, and waste to fuel applications.

Embodiments also include additional processing of the preconditioned absorptive resin aggregate or preconditioned resin aggregate to form a calcium carbonate or limestone layer on an outer surface of the aggregate. Carbon dioxide from an exhaust source is captured and entrained in the limestone layer to advantageously reduce greenhouse gas emissions during formation of the aggregate. The calcium carbonate layer also improves the characteristics or qualities of the aggregate for use across various industries. Such aggregate may also be referred to as a hybrid aggregate that is made from both the plastic and emissions waste streams.

The capture and entrainment of carbon dioxide in the hybrid aggregate may be further improved through the use of nanofibers in the formation of the hybrid aggregate described herein to produce a fiber-reinforced hybrid aggregate (“FRHA”). More specifically, the nanofibers may have a positive charge that attracts and bonds to negatively charged molecules such as carbon dioxide and its derivative carbonic acids. The carbon dioxide that is bonded to the nanofibers becomes entrained in concrete when the FRHA is mixed with cement according to standard industry practices. Further, the nanofibers may wick carbon dioxide into the limestone coating during the direction carbonation process described herein to further improve carbon dioxide capture and entrainment in the FRHA particles. In addition to the significant benefits and advantages of capturing and entraining carbon dioxide in aggregate particles and thus concrete, the nanofibers improve the characteristics of the resulting concrete produced using embodiments of the FRHA particles described herein.

The present disclosure will proceed to describe the formation of preconditioned absorptive resin aggregate or preconditioned resin aggregate first, followed by the additional processing steps of such aggregate to form hybrid aggregate as well as FRHA particles.

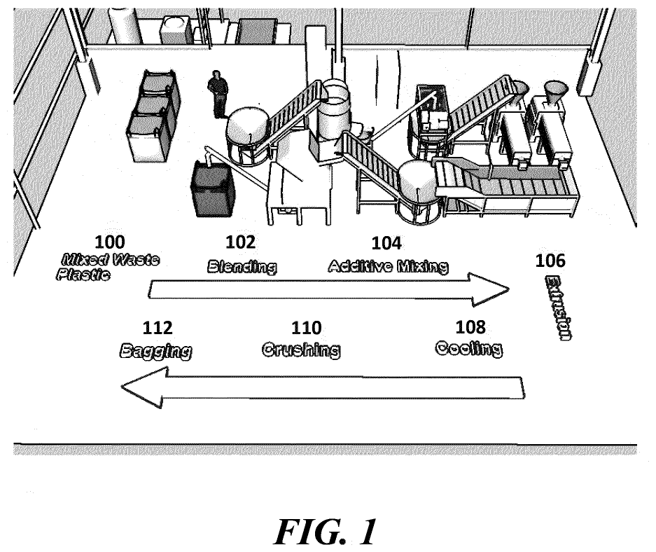

FIG. 1 shows an example of an aggregate production facility with a process flow diagram illustrating aspects of a method of making a preconditioned absorptive resin aggregate according to an example embodiment.

The method may begin at 100 with obtaining a supply of granulated mixed plastic waste treated with a preconditioning agent that comprises, consists or consists essentially of calcium oxide (quicklime or burnt lime) and/or calcium hydroxide (slaked lime). For example, containers of granulated mixed plastic waste treated with the preconditioning agent may be received from one or more waste sources. The waste sources may include, for example, industrial, municipal, and volunteer recovery sources. Advantageously, waste plastics of various types may be collected and comingled with little to no regard to the specific type of plastic materials collected.

To facilitate the methods of making aggregate disclosed herein, comingled waste plastic products (e.g., plastic containers) are preferably ground, shredded, pulverized or otherwise processed to form a granulated mixed plastic waste. In an embodiment, the comingled waste plastic products are acquired via a direct to consumer or direct consumer to recycling model in which a consumer places their plastic waste in a bag, such as a plastic bag or trash bag, among others. Then, a driver or other worker picks up the user's bag of comingled plastic and delivers it directly to a processing plant of the type described herein where it is ground, shredded, etc., as above to produce the granulated plastic waste. As will be described in more detail below, the granulated plastic waste may be incorporated 100%, or at least 95% assuming some waste in processing, by volume or weight into a concrete or other renewable product. Accordingly, embodiments of processes and techniques described herein include acquiring plastic waste directly from consumers and recycling 100% of such waste into renewable products of the type described herein, which is not achievable with current systems and methods that only accept a significantly lower percentage (sometimes 20% or less) of plastic for recycling among a comingled supply, with the remainder being incinerated or buried in landfills.

In addition, the granulated mixed plastic waste may be advantageously treated with a preconditioning agent comprising, consisting, or consisting essentially of calcium oxide (CaO), commonly known as quicklime or burnt lime, and/or calcium hydroxide (Ca(OH)₂), commonly known as slaked lime. This preconditioning agent may act, for example, as a disinfectant and provide a “dry-cleaning” effect to improve sanitation of the granulated mixed plastic waste and reduce foul odors. The preconditioning agent may also act as a desiccant and absorb moisture beneficial to the methods disclosed herein. In some instances, the preconditioning agent may sufficiently disinfect the granulated mixed plastic waste such that it does not present a hazardous material concern. The granulated mixed plastic waste treated with the preconditioning agent may be packaged and shipped as a suitable feedstock for subsequent processing, including the formation of aggregate disclosed herein.

In some instances, it is appreciated that processing systems may be provided at or near recovery collection sites or facilities to minimize the transport of mixed plastic waste products prior to granulation and treatment with the preconditioning agent. In this manner, granulated mixed plastic waste may be transported in a more compact and relatively cleaner form factor for subsequent processing in accordance with embodiments of the methods disclosed herein. Because the preconditioning with calcium oxide and/or calcium hydroxide can help reduce any potential pathogens and eliminate associated odors, it can make backhauling of the granulated mixed plastic waste material much more efficient and environmentally healthy.

The supply of granulated mixed plastic waste may include a variety of plastic materials including high density polyethylene, polypropylene, PVC, ABS, polyurethane, polyamide, and/or PET, as well as other like materials. The supply of granulated mixed plastic waste may further comprise non-plastic material in the form of food residue, cellulosic material and/or metallic foil material, for example. In some instances, the supply of granulated mixed plastic waste may be characterized by waste plastic having a granule size less than a predetermined maximum granule size obtained by shredding and/or pulverizing mixed plastic waste products. The predetermined maximum granule size may be, for example, 25 mm, 20 mm, 15 mm or 10 mm. The supply of granulated mixed plastic waste may have a bulk density that is at least five times greater than a bulk density of the mixed plastic waste products from which the granulated mixed plastic waste is derived, and in some instances may have a bulk density that is at least eight, ten or twelve times greater than a bulk density of the mixed plastic waste products from which the granulated mixed plastic waste is derived. The supply of granulated mixed plastic waste may comprise unwashed and/or unsorted plastics.

The supply of granulated mixed plastic waste treated by the preconditioning agent may include about 4% to about 22% calcium compounds by weight, and in some instances may include about 8% to about 18% calcium compounds by weight, about 11% to about 15% calcium compounds by weight, or about 13% calcium compounds by weight. The supply of granulated mixed plastic waste treated by the preconditioning agent may include at least about 50% waste plastic material by weight, at least about 60% waste plastic material by weight, at least about 70% waste plastic material by weight, or at least about 80% waste plastic material by weight, and in some instances, may include between about 75% and about 99% waste plastic material by weight, between about 82% and about 92% waste plastic material by weight, or about 87% waste plastic material by weight.

Prior to the mixing of the supply of granulated mixed plastic waste treated with the preconditioning agent with the one or more additives, at least some calcium oxide of the preconditioning agent in the supply of granulated mixed plastic waste may be converted to calcium hydroxide through exposure to moisture. For example, some calcium oxide of the preconditioning agent may be converted to calcium hydroxide through exposure to moisture in the surrounding environment, moisture in food residues or other moisture sources. Again, the preconditioning agent may act as a disinfectant and/or a desiccant.

After obtaining the supply of granulated mixed plastic waste treated with the preconditioning agent, the method may in some embodiments continue at 102 with blending the supply of granulated mixed plastic waste with one or more other supplemental sources of granulated mixed plastic waste which may be similarly treated with a preconditioning agent that comprises, consists or consists essentially of calcium oxide and/or calcium hydroxide. For example, a stream of granulated mixed plastic waste from industrial sources may be blended with a stream of granulated mixed plastic waste from municipal sources and/or volunteer recovery sources.

The method may then continue at 104 with mixing the supply (or blended supplies) of granulated mixed plastic waste treated with the preconditioning agent with one or more additives to form a plastic waste mixture. Advantageously, the one or more additives may comprise, consist or consist essentially of pozzolans. Pozzolans include finely divided materials comprising SiO₂ and/or Al₂O₃, which react with calcium hydroxide to form compounds having cementitious properties. Pozzolans embrace a large number of materials which vary widely in terms of origin, composition and properties. Both natural and artificial materials show pozzolanic activity and may be used as supplementary cementitious materials. Commonly used pozzolans include industrial by-products such as fly ash, silica fume from silicon smelting, highly reactive metakaolin, and burned organic matter residues rich in silica such as volcanic ash and rice husk ash. In some particularly advantageous embodiments, the pozzolans mixed with the granulated mixed plastic waste treated with the preconditioning agent may comprise burned organic matter residues, such as, for example, sugar cane ash or rice husk ash. The one or more additives of the plastic waste mixture may further comprise an essence, a fire retardant, and/or an anti-bacterial agent.

The method may continue at 106 with hot extruding the plastic waste mixture to form an extruded product comprising waste plastic material, followed by cooling the extruded product at 108 (such as via a water bath).

The plastic waste mixture to be hot extruded may include about 2% to about 14% of pozzolans by weight and about 6% to about 18% of calcium compounds (e.g., calcium oxide, calcium hydroxide) by weight, about 4% to about 12% of pozzolans by weight and about 8% to about 16% of calcium compounds by weight, or about 6% to about 10% of pozzolans by weight and about 10% to about 14% of calcium compounds by weight. The plastic waste mixture to be hot extruded may include at least about 50% plastic material by weight, at least about 60% plastic material by weight, at least about 70% plastic material by weight, at least about 75% plastic material by weight, or at least about 80% plastic material by weight. The plastic waste mixture may be hot extruded at a processing temperature between about 165° C. and about 230° C., or at other selected temperature profiles. The plastic waste mixture to be hot extruded may consist or consist essentially of the granulated mixed plastic waste treated with the preconditioning agent and the pozzolans. The plastic waste mixture may have a moisture content sufficient to assist in forming internal voids or cavities within the extruded product during the hot extruding of the plastic waste mixture as the moisture is vaporized during the hot extruding process.

For example, the extrusion process may be designed to use the moisture content developed by the desiccant effect of the preconditioning agent in the granulated mixed plastic waste feedstock as a blowing or foaming agent that vaporizes within the extrusion chamber to create an internal open-cell matrix of microbubbles in the extruded product, which may provide additional advantages in the resulting aggregate as discussed elsewhere.

The extrusion process may also provide another phase of waste decontamination and sanitization in which bacteria and viruses are eliminated and organic material denatured, the resulting product being a sanitized environmentally inert hybrid of plastic resin and calcium.

Next, at 110, the method may continue with processing the extruded product to form an aggregate in which the waste plastic material is exposed at exterior surfaces of the aggregate, and in which internal non-plastic additives are similarly exposed. Processing the extruded product to form the aggregate may include crushing and screening the extruded product to meet industry standard sizing requirements for traditional aggregates. This may include crushing and screening the extruded product to form fine aggregates (most particles smaller than 5 mm) or coarse aggregates (particles predominantly larger than 5 mm (0.2 in.) and generally between 9.5 mm and 37.5 mm (⅜ in. and 11/2 in.)).

Advantageously, processing the extruded product may result in exposing the non-plastic additive particles in the extruded product to facilitate, for example, chemical adhesion and cohesion of the aggregate to surrounding material when incorporating the aggregate in a cement product for example. In addition, processing the extruded product may advantageously result in exposing internal microbubble structures which may physically attract moisture in a cement mix, for example, in a process known as wetting. As such, aggregates made according to embodiments of the present invention may become absorptive. The sponge-like open cell physical characteristics of the crushed aggregate may pull the wet cement mix into the aggregate particles and facilitate a structure promoting mechanical cohesion. The ability to produce an absorptive open cell aggregate particle that transports additives (e.g., calcium oxide and pozzolans) to enhance chemical cohesion and comprises an absorptive physical structure to enhance mechanical fastening is believed to be particularly advantageous.

Still further, fibrous extensions may be formed during processing (e.g., crushing, grinding, fracturing) of the extruded product, which fibrous extensions may assist in binding the aggregate to surrounding material when incorporating the aggregate in a cement product for example, and in strengthening the resulting product. The fibrous extensions may act similar to fiber additives used in some concrete products and result in increased strength and/or durability.

In some embodiments, the method may conclude at 112 with packaging (e.g., bagging) the aggregate for storage or transport. Alternatively, the resulting aggregate may be put to immediate use as a component of a lightweight cement product, such as a lightweight cement construction block (including structural construction blocks), or as a feedstock in an industrial process for recovering fuel oil from the aggregate, for example. Still further, the aggregate may undergo additional processing steps to form hybrid aggregate of the type described herein. The production of the hybrid aggregate may occur at the same location as the production of the preconditioned resin aggregate described above, or may occur at a different facility via bagging and transport of the preconditioned resin aggregate.

Accordingly, mixed plastic waste may be converted and permanently fixed within construction materials, thereby eliminating associated environmental impacts of such waste and creating a second use value stream for the waste. Put another way, a mixed-polymer concrete aggregate may be formed by utilizing “dirty” or unmanaged plastic recovered from industrial, commercial and domestic sources and may effectively sequester such waste in concrete building blocks or other concrete products.

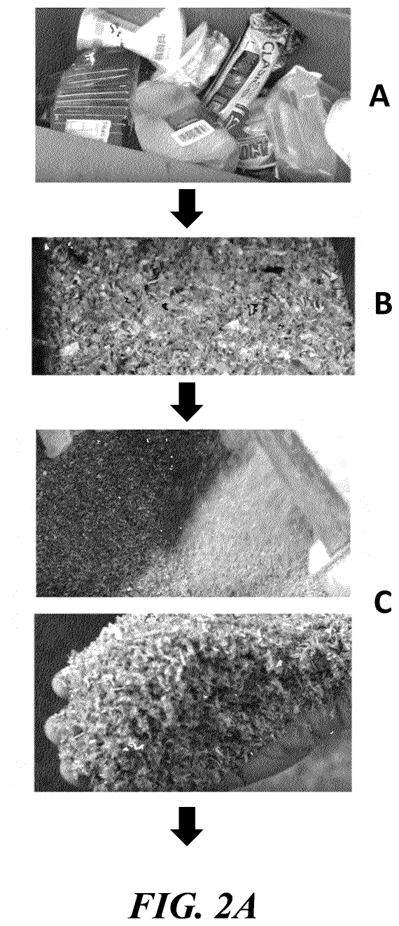

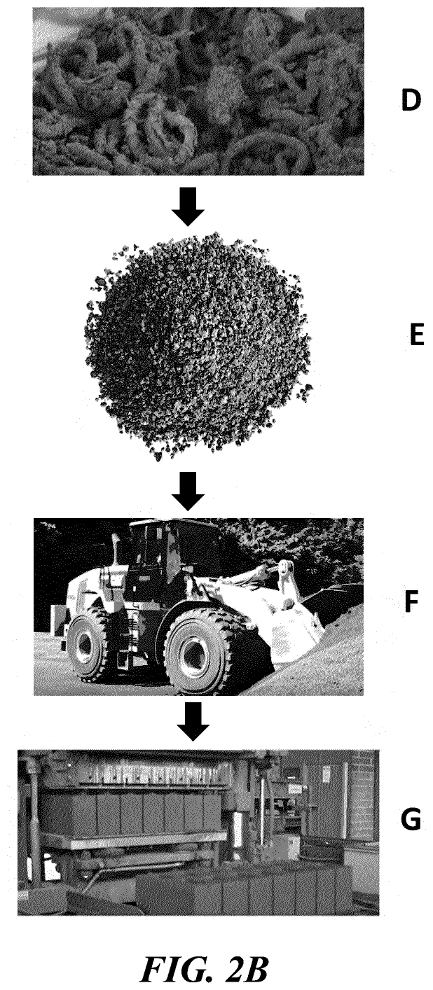

FIGS. 2A and 2B show a process flow diagram illustrating aspects of methods of forming a construction product with the preconditioned resin aggregate described herein. In other words, FIG. 2A and FIG. 2B are a visual representation of a process for forming preconditioned resin aggregate that is the basis for hybrid aggregate described herein. The process in FIG. 2A and FIG. 2B may be similar in some respects to that described above in FIG. 1.

At step A, mixed waste plastic products are collected. The mixed plastic waste products may include a variety of plastic materials, food residue, and non-plastic label components.

At step B, the mixed plastic waste products are processed (e.g., ground and/or shredded) to form granulated mixed plastic waste and a preconditioning agent comprising, consisting or consisting essentially of calcium oxide and/or calcium hydroxide may be introduced.

At step C, the supply of granulated mixed plastic waste treated with the preconditioning agent is mixed with one or more additives to form a plastic waste mixture. Advantageously, the additives may comprise, consist or consist essentially of pozzolans.

At step D, the plastic waste mixture is subjected to a hot extrusion process to form an extruded product comprising waste plastic material.

Then, at step E, the extruded product is processed (e.g., ground and screened) to form an aggregate in which the waste plastic material and additives therein are exposed at exterior surfaces.

At step F, the aggregate may be stored in a manner similar to conventional aggregates for subsequent use. Alternatively, at step F, the preconditioned resin aggregate undergoes further processing to form hybrid aggregate, as described later.

For example, at step G, the preconditioned resin aggregate may be combined with a sand-cement mixture without additional processing to form a lightweight concrete mixture, the lightweight concrete mixture may then be mixed with water to generate a lightweight concrete slurry, and the lightweight concrete slurry may then be formed into a lightweight concrete construction product, such as, for example, a lightweight concrete block. Alternatively, the preconditioned resin aggregate undergoes additional processing to form hybrid aggregate, which may then be combined with other materials as above to form a concrete product.

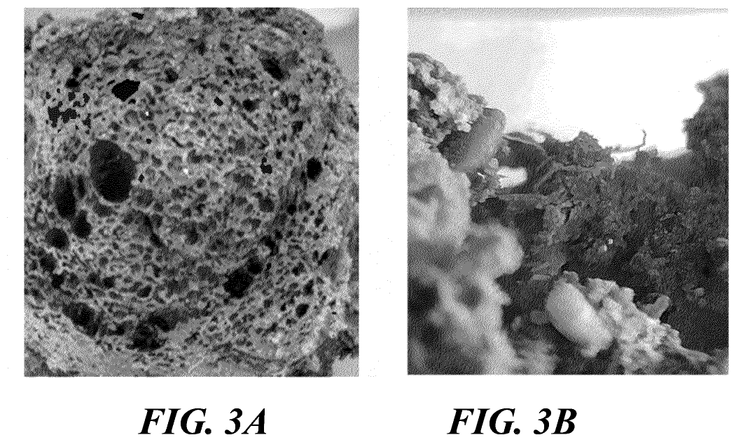

FIG. 3A and FIG. 3B provide enlarged images of example preconditioned resin aggregate prepared in accordance with embodiments of the methods of making preconditioned resin aggregate disclosed above to further illustrate characteristics of the preconditioned resin aggregate, including, in particular, the irregularity of the surface structure and porous nature of the aggregate shown in FIG. 3A. In addition, fibrous extensions from an exterior surface of the aggregate are visible in FIG. 3B.

One problem with discarded plastic waste is that it is a visual contaminant. For humans, this creates a visceral response when encountering waste in natural environments like shorelines. For animals, discarded plastic waste may be mistaken for a food source and is therefore potentially deadly. In construction, colored flecks or particles of plastic in building materials may create concern over strength and quality. As such, providing an aggregate from waste plastics which is characterized by neutral grey tones and is visually benign is seen as one significant benefit of the aggregates disclosed herein. While embodiments of the methods disclosed herein generally result in aggregates with neutral grey tones, it is appreciated that in some embodiments, one or more dyes or other fillers may be utilized to adjust coloration of the resulting aggregate, preferably to resemble the color or colors of natural occurring aggregates used in the construction industry.

Notably, embodiments of the present invention provide a preconditioned resin aggregate comprising mixed waste plastic, calcium oxide and/or calcium hydroxide, and pozzolans (e.g., sugar cane ash, rice husk ash, incinerated paper products) for use in cement products, including structural cement products. The pozzolans play a role in the chemical adhesion of cement to the aggregate. There is also the potential of the calcium oxide and/or calcium hydroxide to interact with the pozzolans to create a pozzolanic reaction internally within the mixture matrix. In addition, calcium oxide will convert to calcium hydroxide when it is exposed to moisture and has the potential to absorb carbon dioxide out of the air to create calcium carbonate or limestone, in a hardening process known as carbonation. As such, the additives (e.g., calcium oxide, calcium hydroxide, pozzolans) provide for conditions within the aggregate to promote both chemical adhesion and cohesion to cement using combined processes of hydraulic, pozzolanic and carbonation reactions. It has been found that the additives (e.g., calcium oxide, calcium hydroxide, pozzolans) play an important role in the “homogenizing” of the commingled mixed plastic resin during the extrusion process which may be due to the hard particle composition assisting in the effective mixing of the various melted polymer chains present in the extruding process.

Apart from the cementitious benefits of using aspects of the lime cycle in embodiments of the present invention, the preconditioning agent acts as a disinfectant of organic matter and an anhydrous desiccant so the addition at the point of recovery, the waste facility or pickup location, has additional public health benefits of killing pathogens and eliminating odors. The strong desiccant behavior of both the preconditioning agent and pozzolans pulls humidity from the air to help the additives slightly moisten and evenly cover the granulated mixed plastic waste particles. This coverage of the granulated mixed plastic waste particles with the additives also has the added benefit and effect of further densifying the lightweight particles and making them easier to feed into machinery during the extruding process.

Advantageously, shredding or crushing of the mixed plastic waste at the recovery location can assist in “dry-cleaning” the waste. The shredding machines may be provided in the form of rotary knives or rolling crushing drums and may aggressively mechanically cut and/or crush the mixed plastic waste into particles, preferably to a size of 25 mm or less, 20 mm or less, 15 mm or less, or 10 mm or less. This aggressive mechanical action can effectively knock off any debris, sand, plant matter, dried food, etc. and can produce a much cleaner bulk waste material. Thus, before the preconditioning agent is mixed in following this initial mechanical agitation, the granulated mixed plastic waste is already much cleaner than the original waste feedstock. This is advantageous in that in this “dry-cleaning” process eliminates the use of water to clean the feedstock which provides both environmental and financial benefits to the recovery location.

Another advantage of embodiments of the present invention is the ability to process PVC waste in addition to other plastic materials. PVC can be difficult to deal with in standard recycling process as it often mistaken for PET and can contaminate the recyclability of PET as it blackens at very low temperatures and has a yellowing effect on the PET if commingled therewith. Unlike other thermoplastics which are essentially hydrocarbon chains, PVC is made up of a large proportion of chlorine which dehydrochlorinates at elevated temperatures releasing toxic HCl gas. PVC has good ultraviolet properties and a very low flammability, characteristics that make it a preferred plastic material in the construction industry. Therefore in the production of aggregates according to embodiments described herein, PVC represents a valuable feedstock. The tendency for PVC to blacken or darken is considered an advantage when producing desired color tones to camouflage and color the aggregate to make it visually benign and/or to capture the same tones of the cement products that may be produced with the aggregate. It has been found that commingled mixed waste plastic naturally provides a light to dark grey tone when extruded together but can be modulated by a couple of factors such as processing time and temperature (the longer the processing time and higher the temperature, the darker the resulting aggregate), as well as the proportion of PVC in the feedstock. Therefore, in some embodiments, PVC may be used as a tinting agent to achieve a desired color tone of the resulting aggregate.

As previously discussed, preconditioned resin aggregate formed in accordance with embodiments of the present invention can be used in other industries besides the construction industry, such as, for example, a preconditioned feedstock for waste to energy programs like pyrolysis. PVC can pose certain problems for processing in pyrolysis because of it HCl off-gassing as pyrolysis of plastic generally happens at the 300-500° C. temperature range. Current research indicates that calcium oxide, calcium hydroxide and calcium carbonate all act as HCl gas absorbers by creating a calcium chloride salt which can be an effective soil enhancer and stabilizer. As such, the aggregates described herein may be of interest to the petrochemical industry as the calcium to “scrub” HCl out of high-temperature pyrolysis methods may be present in the aggregates. The potential benefits include that the aggregates produced in accordance with embodiments of the present invention are environmentally benign and safe to ship and store.

Meanwhile, carbon capture and utilization is becoming an increasingly important new field within various industries with one example being the construction industry. In fact, cement structures are being recognized as potentially one of the planet's better carbon sinks. Typically, concrete hardens through hydration with the addition of water, but some residual Ca(OH)₂ found in concrete continues to absorb CO₂ very gradually from the air through a process of carbonation. Advantageously, embodiments of the present disclosure enable an increase in the amount of carbon captured in concrete while also improving the properties or characteristics of the aggregate and in some embodiments, the finished concrete products.

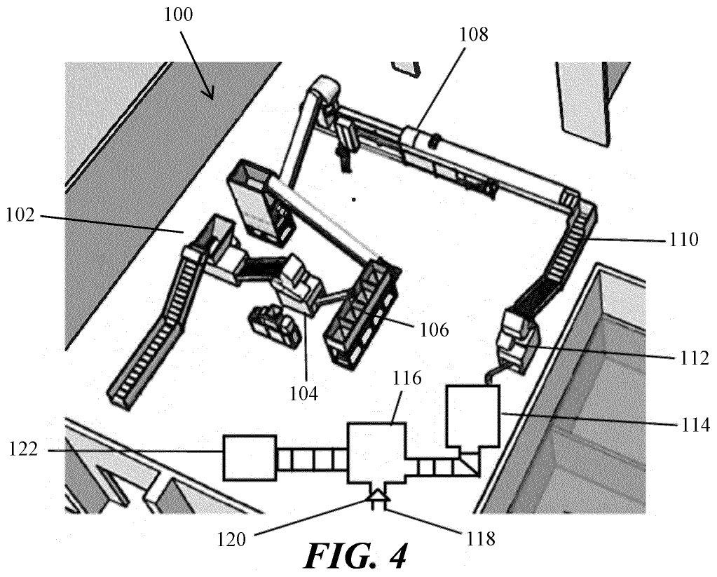

FIG. 4 shows an example embodiment of an aggregate production facility 100 illustrating aspects of the methods of making a hybrid aggregate disclosed herein.

The initial steps of the method are similar to those described above for forming preconditioned resin aggregate. In sum, waste plastic is shredded at 102, the shredded waste is pre-conditioned with calcium hydroxide (Ca(OH)₂) and/or ash at 104, the pre-conditioned waste is batched by density at 106 and fed through an extruder at 108. The extruded plastic waste material is cooled at 110 and granulated at 112 to form preconditioned resin aggregate or preconditioned absorptive resin aggregate.

The method then continues by feeding the preconditioned resin aggregate into a mixer at 114. The mixer may be a conventional cement mixer and may include an inlet for receiving cement powder in the mixer as well as an inlet for receiving water in the mixer, along with the preconditioned resin aggregate. The mixer rotates or otherwise agitates the combination of ingredients to batter the preconditioned resin aggregate at 114 with cement or a cement slurry. In some embodiments, the cement includes calcium hydroxide (Ca(OH)₂).

Then, at 116, the battered preconditioned resin aggregate (i.e. the preconditioned resin aggregate with a cement powder or cement slurry coating) is fed into a reactor. The reactor may be any reactor now available or available in the future. In the reactor, the coated or battered preconditioned resin aggregate is interacted with flue gases from an external exhaust source via line 118. The line 118 and reactor 116 generally may include various valves, such as valve 120, to control the rate or volume of flue gas input to the reactor.

During the comparatively short, accelerated curing phase, the carbon dioxide (CO₂) reacts with the calcium hydroxide (Ca(OH)₂) that is coated or battered on the preconditioned resin aggregate and is crystallized into calcium carbonate (CaCO₃), or limestone. Given the selected conditions of moisture content and reactivity timing during the curing phase of cement, direct carbon dioxide (CO₂) uptake is very efficient and immediate. These ideal conditions of exposure can be created by exposing the cement paste to warm industrial flue gas while also controlling the timing and moisture content in the cement that is battered or coated on the preconditioned resin aggregate. In some embodiments, the calcium hydroxide to calcium carbonate reaction takes place at the surface of the exposed cement to form a thin shell around the preconditioned resin aggregate particles and generate the hybrid aggregate discussed herein.

When the preconditioned resin aggregate particles are covered or battered with a cement paste and exposed to flue gas, they exhibit the perfect conditions to absorb or capture significant quantities of carbon dioxide (CO₂) and convert it into a shell-like limestone encapsulation with a hardened interior around an entirety of the preconditioned resin aggregate particles. In some embodiments, the battered preconditioned resin aggregate particles absorb or capture carbon dioxide (CO₂) in an amount up to 50% by weight of the cement coating, or more in some examples, including at least 60% by weight, 70% by weight, 80% by weight, 90% by weight, and/or 100% by weight, including intervening values to two decimal places. Moreover, the structure of the preconditioned resin aggregate particles, which may be porous and have fibers extending from the exterior surface ensures a strong adhesion between the preconditioned resin aggregate and the limestone layer or casing. Further, carbon dioxide is removed from the industrial flue gas and captured or entrained in the hybrid aggregate in some embodiments. Thus, the processing of hybrid aggregate works as a final step of flue gas filtration and carbon dioxide (CO₂) reduction while creating a resulting particle with improved construction qualities.

The hybrid aggregate particles discussed herein present an alternative to incineration of plastic waste, as well as an option for carbon capture and utilization. The avoided greenhouse gas emissions lead to a direct climate change benefit, whilst the capture of carbon dioxide from industrial flue gas creates a cementitious product with a lower carbon footprint than standard cement.

The method may terminate at 122 with bagging, storage, and/or transport of the hybrid aggregate, which may be similar to the process described herein with reference to FIG. 1 and the preconditioned resin aggregate.

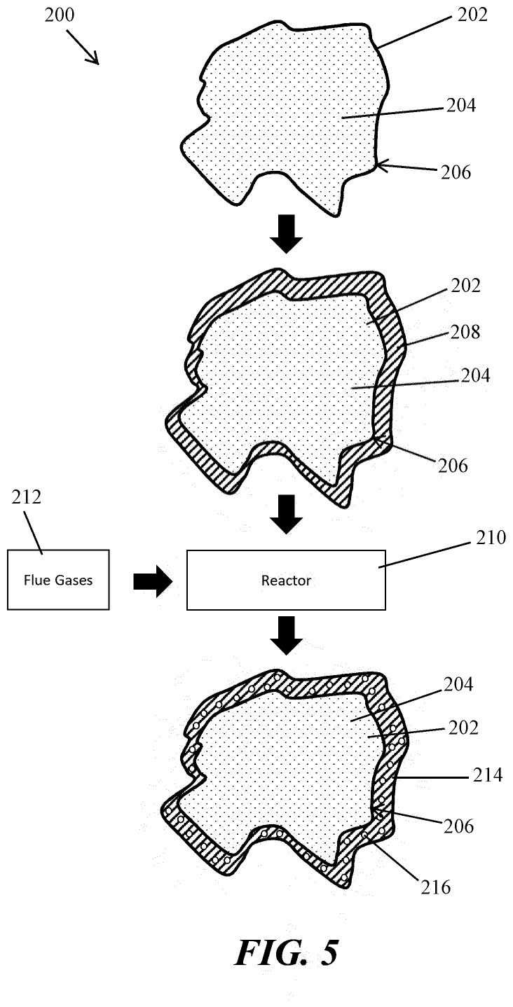

FIG. 5 shows a process flow diagram of a method 200 for forming a hybrid aggregate from preconditioned resin aggregate made according to embodiments of the present disclosure. In particular, FIG. 5 illustrates schematic cross-sectional views of an example piece of preconditioned resin aggregate 202 and the effect of the processing steps on the preconditioned resin aggregate 202 in forming hybrid aggregate. Although FIG. 5 illustrates only one preconditioned resin aggregate particle 202, it is to be appreciated that the same processing steps can be applied to bulk preconditioned resin aggregate particles prepared in accordance with the methods herein.

The method 200 begins with the piece of preconditioned resin aggregate 202 that may be formed by any method described herein. As described earlier, the preconditioned resin aggregate 202 has a porous structure with pores or holes 204 dispersed through the preconditioned resin aggregate 202 in the cross-sectional view. While the pores 204 are shown as aligned in rows and columns, it is be appreciated that this pattern is solely for ease of recognition in the drawings and that in practice, the pores 204 may be aligned randomly due to the circumstances of their formation (see FIG. 3A). The fibrous extensions extending from an exterior surface 206 of the preconditioned resin aggregate 202 are present (see FIG. 3B), but are not shown in detail at the scale of FIG. 5.

The preconditioned resin aggregate 202 is then coated with cement 208, which may also be a cement slurry including a combination of cement and water that may be referred to herein as a batter. The amount of cement and water can be selected based on various factors, such as the timing of the initial cure phase of the cement 208. The cement 208 is distributed around an entirety of the exterior surface 206 of the preconditioned resin aggregate 202 in some embodiments. Further, the cement 208 may have a uniform thickness or a substantially uniform thickness around the preconditioned resin aggregate 202 in one or more embodiments. However, the coating process may not be entirely even in practice, such that a thickness of the cement 208 on the resin aggregate 202 may vary to some degree around a perimeter of the resin aggregate 202. The cement 208 may also interact with the fibrous extensions on the exterior surface 206 of the resin aggregate 202 as well as pores 204 of the resin aggregate 202. In other words, because the cement 208 is a slurry, the cement 208 will fill or penetrate into some or all of the pores 204 as well as encapsulate the fibrous extensions to improve adhesion of the cement 208 to the preconditioned resin aggregate 202.

Once the preconditioned resin aggregate 202 is coated with cement 208, the combined particle is fed into a reactor 210 along with flue gases 212. The flue gases 212 may originate from any external source, such as an incinerator, a refinery, a smelting machine or process, an exhaust tower, or any other industrial process that produces carbon dioxide (CO₂). As mentioned previously, the rate and volume of flue gas 212 that is introduced to the reactor 210 may be selected according to design characteristics, including but not limited to the amount of cement covered resin aggregate 202 in the reactor 210, the reaction rate of the flue gas 212 with the cement covered resin aggregate 202, the temperature or specific heat content of the flue gases 212 and in the reactor 210, the size of the reactor 210, the carbon dioxide concentration of the flue gases 212, the amount of time the cement covered resin aggregate 202 and the flue gases 212 are present in the reactor 210, or any combination thereof, among others.

The process 200 further includes selecting a timing for introduction of the cement covered preconditioned resin aggregate 202 to the flue gases 212 in the reactor 210 based on characteristics of the cement 208, the reactor 210, and the flue gases 212, among others. In some embodiments, the cement covered preconditioned resin aggregate 202 is introduced to the reactor 210 and flue gases 212 at the peak of the initial curing phase of the cement 208, or when the cement 208 is in its most reactive phase during the initial curing process. Feeding the cement covered preconditioned resin aggregate 202 into the reactor 210 in the initial reaction or curing phase enables interaction between the cement 208 and carbon dioxide (CO₂) in the flue gases 212. The carbon dioxide (CO₂) reacts with the calcium hydroxide (Ca(OH)₂) in the cement 208 coated or battered on the preconditioned resin aggregate 202 and is crystallized into a limestone or calcium carbonate (CaCO₃) layer 214 on the preconditioned resin aggregate 202.

As shown in the bottom image of FIG. 5, the limestone layer 214 encapsulates the preconditioned resin aggregate and is present on an entirety of the exterior surface 206 of the preconditioned resin aggregate 202 in some embodiments. Further, the pores 204 and the fibrous extensions of the resin aggregate 202 increase adhesion to the limestone layer 214. Thus, the formation of hybrid aggregate absorbs or captures carbon dioxide (CO₂) through a reaction between the carbon dioxide (CO₂) and the calcium hydroxide (Ca(OH)₂) in the cement 208. In one or more embodiments, carbon dioxide (CO₂) may also be entrained or encapsulated in the limestone layer 214 during formation of the limestone layer 214, as represented by circles 216. In other words, when the flue gases 212 containing carbon dioxide (CO₂) are incident on the wet cement 208 on the resin aggregate particle 202, the flue gases 212 and some carbon dioxide (CO₂) may mix with, and be trapped inside, the limestone layer 214 as it hardens. Thus, the hybrid aggregate may also capture some carbon dioxide (CO₂) through this additional process.

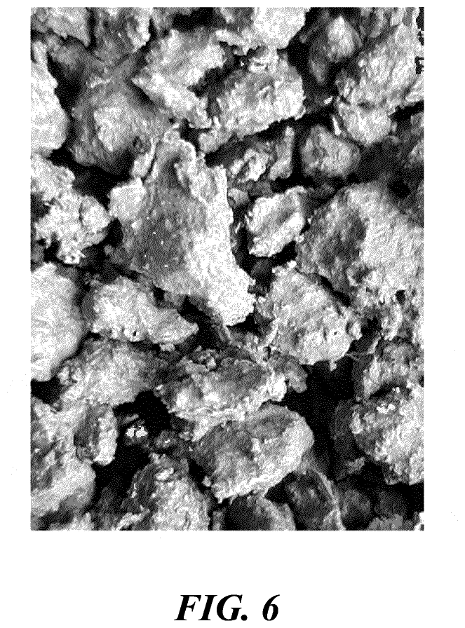

FIG. 6 provides an enlarged image of example hybrid aggregate prepared in accordance with embodiments of the methods of making hybrid aggregate disclosed above to further illustrate characteristics of the hybrid aggregate, including, in particular, the visually benign nature of the hybrid aggregate and the shell-like limestone coating on an entire exterior surface of the preconditioned resin aggregate particles. Because the limestone layer is natural stone, the resulting aggregate has a visually benign appearance that is similar or identical to nature stone. Further, the cement may contain additives or coloring agents to improve the visually benign and natural appearance of the resulting limestone layer of the hybrid aggregate particles.

As shown in FIG. 6, the limestone coating on the hybrid aggregate particles does not necessarily impact the irregular surface structure of the preconditioned resin aggregate particles. Put differently, the hybrid aggregate particles may still have an irregular surface structure, although the pores may be covered by the limestone layer. Despite this change in surface appearance, the hybrid aggregate particles shown in FIG. 6 may improve the characteristics of concrete products that incorporate hybrid aggregate due to the limestone layer. In one non-limiting example, the limestone layer not only captures carbon dioxide (CO₂), but advantageously improves the strength of concrete formed with the hybrid aggregate particles due to increased adhesion between the cement and the limestone layer. Further, the irregular surface structure may also improve the strength of the concrete because the cement has more surface area as well as irregular surfaces and edges to bond to. Thus, hybrid aggregate particles may be useful in wider range of cementitious products, such as ready-mix concrete, bagged mortars and concrete mixes, and structural concrete applications, in addition to those described above for preconditioned resin aggregate. The limestone layer also enables use of the hybrid aggregate particles in higher proportions in some concrete applications due to the enhanced strength characteristics.

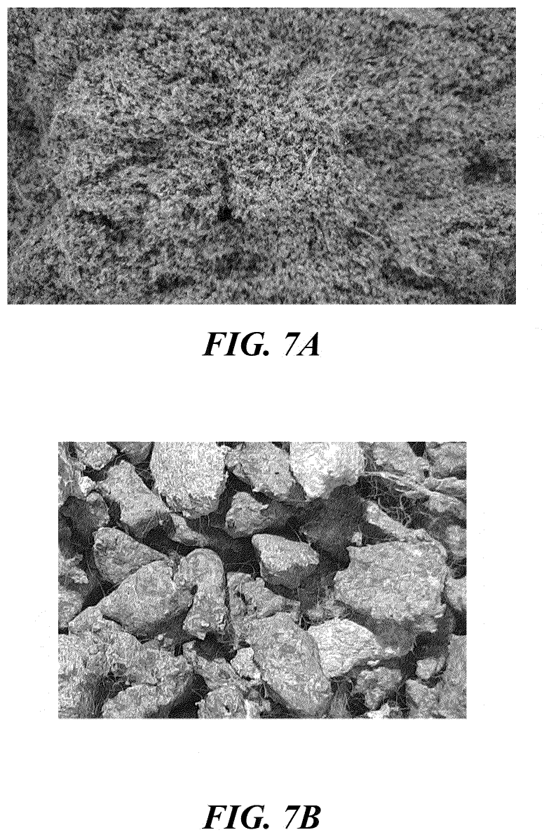

FIGS. 7A and 7B are enlarged images of an example fiber-reinforced hybrid aggregate prepared in accordance with embodiments of the methods of making fiber-reinforced hybrid aggregate disclosed herein. As alluded to above, the capture and entrainment of carbon dioxide in the hybrid aggregate may be further improved through the use of nanofibers in the formation of the hybrid aggregate described herein to produce a fiber-reinforced hybrid aggregate (“FRHA”).

More specifically, the nanofibers may have a positive charge that attracts and bonds to negatively charged molecules such as carbon dioxide and its derivative carbonic acids. The carbon dioxide that is bonded to the nanofibers becomes entrained in concrete when the FRHA is mixed with cement according to standard industry practices. Further, the nanofibers may wick carbon dioxide into the limestone coating during the direction carbonation process described herein to further improve carbon dioxide capture and entrainment in the FRHA particles. In addition to the significant benefits and advantages of capturing and entraining carbon dioxide in aggregate particles and thus concrete, the nanofibers improve the characteristics of the resulting concrete produced using embodiments of the FRHA particles described herein.

As shown in FIG. 7A and FIG. 7B, the nanofibers bond to the hybrid aggregate particles (i.e., are encapsulated in the limestone layer) and have tails that extend from the facial shell which further increases adhesion and bonding between the FRHA particles and the cement paste matrix with any concrete mix. Fiber reinforcement also improves properties of finished concrete products including the FRHA particles, such as compression and flexural strength while reducing cracking and shrinkage. In some embodiments, the fiber reinforcement systems, devices, and methods described herein can be applied to any suitable aggregate particle, such as recycled construction rubble in one non-limiting example, although the aggregate particles of the present disclosure are ideally suited for incorporation with fiber reinforcement according to the processes described herein.

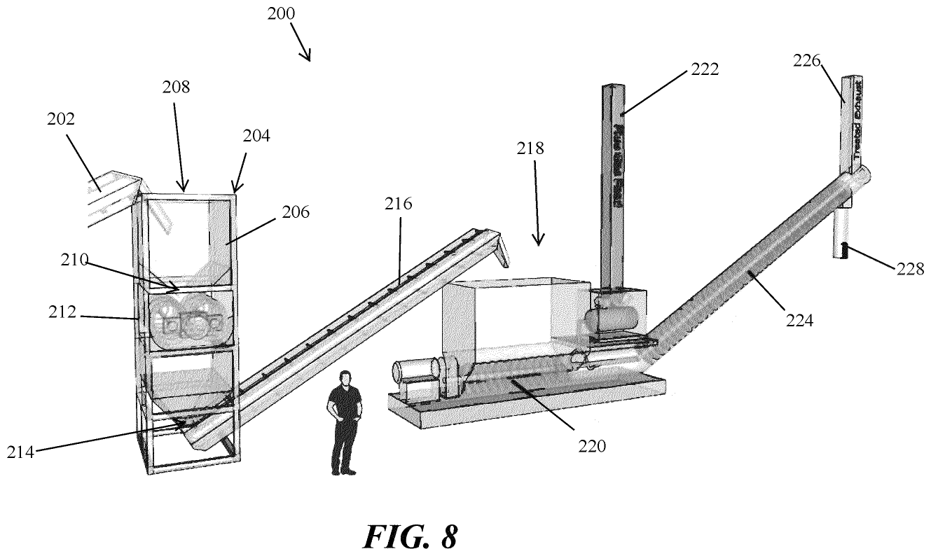

FIG. 8 is a schematic illustration of processing machinery for forming FRHA particles in accordance with the embodiments of the present disclosure. In particular, FIG. 8 provides additional detail regarding processing machinery 200 described schematically in FIG. 4 for mixing, battering, and reacting preconditioned resin aggregate to form hybrid aggregate or FRHA particles. The initial processing steps for forming preconditioned resin aggregate are similar to those described herein and thus will not be repeated.

The process of forming hybrid aggregate or FRHA particles from preconditioned resin aggregate begins with feeding preconditioned resin aggregate along conveyor 202 to a mixer 204. The conveyor 202 may be connected to, or in communication with, an outlet of reference 112 in FIG. 4 (i.e., an outlet for the preconditioned resin aggregate after initial processing). The mixer 204 includes a hopper 206 for receiving and temporarily storing material from the conveyor 202. The material passes into the hopper 206 via a first opening 208 at a first end of the hopper 206 that is communication with an end of the conveyor 202. A second opening 210 of the hopper 206 at an opposite end of the hopper 206 feeds the material to a mixing assembly 212 of the mixer 204. The mixing assembly may be any available type of mixing assembly, such as a paddle mixer, a static mixer, a high shear mixer, a drum mixer, a screw mixer or auger, a blender, a planetary mixer, a homogenizer, an agitator, a batch mixer, or a ribbon mixer in some non-limiting examples.

In some embodiments, the preconditioned resin aggregate is mixed with cement paste or cement powder and water at the mixing assembly 212. The cement paste may include nanofibers to form a nanofiber impregnated cement paste that is battered or coated on the preconditioned resin aggregate at the mixing assembly 212. Preconditioning the resin aggregate with the nanofiber impregnated cement paste results in FHRA particles after the additional processing steps described below. Alternatively, preconditioning the resin aggregate with cement paste without nanofibers results in hybrid aggregate particles after the additional processing steps described below. Alternatively, in some embodiments, the preconditioned resin aggregate is coated or battered with the cement paste, with or without nanofibers, upstream of the hopper 204, such that conveyor 202 delivers battered or coated preconditioned resin aggregate particles to the hopper 204. In yet further embodiments, the preconditioned resin aggregate particles may be battered or coated with the cement paste at a reactor downstream from the hopper 204.

The material from the hopper 204 passes through opening 214 at the bottom of the hopper 204 to a further conveyor 216 for transmission to a reactor 218. The reactor 218 includes a screw 220 for advancing the material toward a flue gas feed 222. As alluded to above, in some embodiments, the preconditioned resin aggregate is battered or coated with the cement paste at the reactor 218, instead of at, or upstream of the hopper 204 and the mixing assembly 212. The screw 220 advances the battered or coated particles through the reactor 218. The flue gas feed 222 delivers flue gases containing carbon dioxide into the reactor 218. As shown in FIG. 8, the flue gas passes through the feed 222 and into the reactor 218. Specifically, an outlet of the flue gas feed 222 may be in communication with a distal end of the screw 220 such that the flue gases interact with the battered or coated particles proximate the end of the screw 220. In some embodiments, the flue gases from the feed 222 empty into a chamber that is sealed from the portion of the reactor 218 containing the screw 220 to prevent flue gases from being emitted through the opening for receiving the aggregate particles at the top of the reactor 218.

Instead, the flue gases are fed into a sealed chamber and a further screw 224 moves the coated particles along a mixing chamber where the particles interact with the flue gas for a selected period of time, which may be any selected number of minutes or hours in some non-limiting examples. The excess flue gas is then emitted through an exhaust 226 and the FRHA particles exit the reactor through outlet 228. As described herein, the particles uptake CO₂ and entrain the CO₂ in the limestone casing in the mixing chamber with the screw 224. Further, electrophilic reactions between the fibers of the FHRA particles sequester additional carbon dioxide on the fibers which then become entrained in concrete when the FHRA particles are mixed with cement and other additives to form concrete.

The most common type of cement is hydraulic-curing Portland cement which is typically made of a mixture of limestone (CaCo₃) and silica clays in an energy intense rotary kiln process known in the industry as calcination. The resulting calcium silicate hydrates C-S-H or clinker is ground and finally hardens in concrete matrixes when mixed with water in a process of hydration, but these calcium oxide rich components can also carbonate in the presence of CO₂ converting them into calcium carbonate compounds such as limestone. This process is known as active carbonation and is receiving significant attention as it has the possibility to sequester or capture large volumes of atmospheric carbon into concrete infrastructure and therefore lowering the construction Industries carbon footprint. The particles described in the present disclosure, as well as the methods of forming aggregate particles according to the present disclosure, are particularly well suited for active carbonation because formation of the limestone casing or layer on the particles uptakes carbon dioxide from the flue gas stream. Further, the nanofibers help wick carbon dioxide into the casing and may also sequester additional carbon dioxide in a secondary reaction.

In some embodiments, effective concrete carbonation uses a controlled exposure of the cement product to concentrated CO₂ concentrations, a process which occurs most efficiently during the acceleration phase of the cement curing process when the exothermic reactivity and electron exchange is at its peak. In some embodiments, this period of time is 5-8 hours after mixing the concrete with water. Thus, the cement paste on the particles is preferably introduced to the flue gas from the flue gas feed 222 within 5-8 hours of mixing the cement with water in one or more embodiments. The residence time of the coated particles with the flue gas may also be selected and may be 30 minutes or less, 1 hour, 2 hours, 3 hours, 4 hours, or more in some non-limiting examples, inclusive of all intervening values. Controlled carbonation can result in multiple benefits in terms of mechanical performance or environmental impact of the concrete. As an example, nanofiber reinforced concrete mixtures are recognized as generally being more susceptible to carbon dioxide uptake due to the increased porosity at the fibre/cement paste interface. The carbon dioxide wicks into the matrix closely following the “coastline” of the fibre strand. Therefore, diffusion through and around the fibre interface also improves the controlled carbonation processes described herein.

Ensuring the correct timing of exposure of the cement paste to the carbon dioxide from the flue gas feed 222 and recognizing the limited depth of carbon dioxide absorption and reactivity dictate that very thin sections of curing cement paste are utilized in some preferred embodiments. While thicker coatings of cement paste are contemplated herein, it is has been found that thin layers of cement paste are more effective. Theoretical calculations suggest that almost 100% carbonation efficiency is possible using the concepts of the present disclosure, meaning that 1 ton (“t”) of cement could absorb 0.5 t of carbon dioxide to form 1.5 t of solid calcium carbonates or limestone. Therefore, several factors and process steps described herein can be optimized to increase the carbonation efficiency, such as the thickness of the cement paste coating layer, aggregate particle size, length of reaction time with the flue gas, flue gas temperature or reaction temperature in the mixing chamber containing screw 224, residence time between the battered or coated particles and the flue gas, and the timing of introduction of the flue gas relative to the reaction phase of the cement paste in some non-limiting examples. It is to be appreciated that the above factors may be selected to be any value.

Parallel to the direct uptake of carbon dioxide into the outer coating and recognizing that carbon dioxide is electrophilic, a secondary electrostatic absorption of carbon dioxide becomes feasible directly onto the fibrous tails of the particles. In what is known as the triboelectric series, when certain materials with opposite charges encounter each other, they create a static electricity and take on either a positive charge or a negative charge. This is particularly true of fibrous materials and textiles. Most synthetic plastics take on a negative static charge in the triboelectric series with woven polypropylene fibers used in surgical masks being a prevalent example. The charge effectively attracts contaminated particles and enhances the filtration properties by including electrostatic attraction and adhesion. Nanofibers that are electrostatically charged are known as electret fibers and are a growing area of filtration research. Nylon fibers are unique in that they are at the other end of the triboelectric series and take on a positive charge. Electrostatically charged nylon nanofibers therefore have the potential to attract negatively charged molecules such as carbon dioxide and its derivative carbonic acids.

Therefore, the nanofibers used for the aggregates discussed herein, such as for FHRA particles, are positively charged nylon nanofibers in some embodiments. They not only wick carbon dioxide into the outer coating of the cement paste during the direct carbonation process described above, but they also have the potential to electrostatically induce or attract excess carbon dioxide and carbonic acid directly on to the charged electret nylon nanofiber itself. The carbon dioxide from the flue gas that has been attracted and bonded to the electrostatically charged FRHA particles is then evenly dispersed in measured dosages into the concrete matrix through standard mixing. The carbon dioxide-rich FRHA particles then readily react with calcium carbonates in the cement matrix in a controlled carbonation process. As a result, the common utilization of nylon fiber as a reinforcing medium in the concrete industry is further exploited and used in direct carbonation through CO₂ wicking and the induction of additional CO₂ by electrostatic attraction in some embodiments.

The nanofibers can be provided with a charge through one of several different methods, including mixing or agitation, or both, with any of the devices described herein. In some embodiments, the processing machinery 200 further includes a drum mixer that receives bulk nanofibers and rotates to rub the fibers against each other. The friction between the fibers creates static electricity that gives the fibers their positive charge and allows the fibers to bond to carbon dioxide from the flue gas. In some embodiments, the fibers are charged with the drum mixer prior to adding the fibers to the cement paste. The fibers can be charged in the drum mixer for a selected period of time, such as 5 minutes or less, 10 minutes, 15 minutes, 30 minutes, 45 minutes, or 1 hour or more, inclusive of all intervening values. After charging, the nanofibers are added to the cement paste and coated on the particles before interaction with flue gas to produce the FRHA particles described herein.

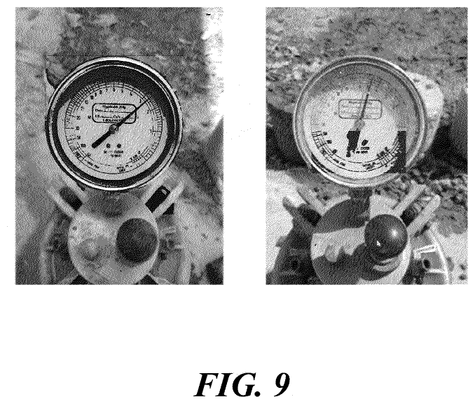

FIG. 9 is a side-by-side photograph of an air entrainment gauge demonstrating test results from the combination of fiber-reinforced hybrid aggregate with cement in accordance with the embodiments disclosed herein.

Initial and ongoing testing has indicated that the processing steps and aggregate particles described herein are contributing, dispersing, and releasing a considerable amount of carbon dioxide into concrete test samples. For example, one estimate is upwards of 200 kg carbon dioxide per ton of FRHA particles added to concrete. A complete quantitative analysis will be determined by further lab testing coupled with a complete and thorough life cycle analysis. This significant uptake is most evident in the amount of free water that is created during mixing because water is a chemical by product of the calcium hydrate and carbon dioxide reaction as well as in significant increases in retained air. Recent results have demonstrated that a relatively small 2% by volume addition of FRHA particles can result in a 78% increase in air entrainment and a 107% increase in slump, which indicates that FRHA particles are extremely reactive and actively carbonating the bulk concrete mix. For example, the left image in FIG. 9 is a concrete test sample using industry standard aggregate with a retained air percentage of just below 3%. The right image in FIG. 9 is a concrete test sample utilizing FRHA particles as an additive or aggregate and demonstrates almost 5% retained air. These results point to significant carbon capture and entrainment in the concrete via the FRHA particles, as described herein.

Retained air is an important element especially in areas where the freeze-thaw cycle is a consideration. The micro bubbles that are dispersed through the concrete matrix help control expansion and contraction and have a major impact on the durability and surface quality of the concrete element. Slump is also important and relates to workability and material flow properties of the fresh concrete. Too much water can significantly decrease the final strength of the concrete, so additives such as plasticizers are typically used to maintain strength. Plasticizers and air entrainment additives increase product cost and could be completely or partially substituted by the FRHA particles described herein.

Thus, the aggregate particles described herein can also function as a plasticizer and allow for a reduced water to cement ration that can assist in creating stronger concrete or optionally the ability to lower the overall cement content and still achieve the final target strength in some embodiments. One advantage of the aggregate particles described herein is almost immediate strength acceleration through the partial carbonation of the concrete matrix which provides high early strength and a denser concrete. Early strength concrete is extremely valuable to the construction industry as it can radically improve curing space limitations, form stripping, shipping logistics, and the overall improved time to project completion.

Furthermore, appreciating that one of the immediate by-products of the cement carbonation reaction is water, the design mix can be adjusted to use a lower water to cement ratio to compensate for the additional water produced by the cement carbonation as water reduction is known to increase concrete strength. Therefore, through direct carbonation and water reduction, the FRHA particles described herein could decrease the amount of cement used to obtain the same compression values of control samples. Small reductions in cement content can have a significant impact in carbon dioxide emissions in the aggregate in the construction industry and FRHA additive can be credited for that reduction. Current test results indicate a 6% drop in cement in 27 MPA concrete mix design using a 2.2% (by volume) addition of FRHA particles. Thus, it is possible to make the processes described herein carbon neutral all the way through the entire plastic life cycle from resource extraction to product manufacture to recovery and finally to repurposing into FRHA particles.

Thus, in sum, the present disclosure describes systems, devices, and methods for converting recovered waste plastic into beneficial concrete additives that can significantly improve the net carbon emissions of producing concrete among many other positive environmental benefits, including but not limited to reducing the burning of plastic and emission of green house gases as well as creating a cyclic life cycle for recycling waste plastic. In some embodiments, the recovered waste plastics are shredded, commingled, and mixed with calcium hydroxide and pozzolans then sintered through heat extrusion into an open cell foam cylindrical section which is finally granulated to a particle size gradation according to industry standards. The supply of granulated mixed plastic waste treated with the preconditioning agent according to the disclosure may also be mixed with one or more additives, such as an essence, a fire retardant, pozzolans, and an anti-bacterial agent, among others. The most basic form of the particles described herein, such as preconditioned resin aggregate or hybrid aggregate, is sold in bulk and functions as an environmentally and visually benign lightweight aggregate principally used in dry-mix precast products. The enhanced physical properties that it imparts into concrete products makes it a best-in-class artificial aggregate. The disclosure also contemplates a wide range of concrete products, including but not limited to poured in place concrete, pre-formed concrete products, concrete blocks of different sizes, shapes, and applications, concrete pavers, and other products that incorporate aggregate or devices described herein or that are otherwise produced using at least some aspects of the techniques and processes described herein.

FRHA particles are a cutting-edge, multi-purpose, concrete additive that brings multiple benefits to poured in place concrete by improving the physical properties of the concrete via controlled carbonation of the FRHA particles. In general, the aggregates described herein have been demonstrated to increase binder strength, flexibility, fire ratings, thermal and acoustic properties of concretes, in addition to the other improvements discussed herein. As a recycled product, it is fully circular at the end of life and has a low embedded energy production footprint providing it with exceptional environmental credentials. The aggregate particles described herein are designed specifically to adhere mechanically and chemically with cement paste through their absorptive open cell structure and hybridized hydrophilic mineral makeup.

Advantageously, these same characteristics also position the particles as an ideal medium for carbon capture and utilization as described above. The aggregates described herein have the potential to significantly reduce atmospheric carbon levels, enrich waste plastic into a carbon neutral construction commodity and appreciate it into societal value. The unique thermal properties of the aggregates can reduce buildings operational energy costs and therefore become net zero over time through accumulated energy savings. The aggregates described herein also provide a positive impact throughout the entire waste plastic and construction products value chain. The aggregates display stand alone environmental credentials and are capable of absorbing the global mismanaged plastic waste steam while simultaneously making a net reduction on green house gas levels.

The aggregate particles described herein also satisfy circular economy and net-zero building development goals in various industries. These goals focus on a project's environmental considerations including transportation radius, embedded carbon or manufacturing energy, footprint of material uses, material durability, sustainable sourcing, and of course ongoing operational energy and efficiency. One of the main design considerations is what is known as material “deconstruction” or the planned re-use of elements or materials at building's “end of life”. With concrete products, there is a growing market for reused or recycled concrete rubble in recycled aggregate. The aggregates described herein go even further because it is indefinitely reusable and recyclable through each evolving new life cycle of concrete, and the aggregates are produced from plastic waste streams that would otherwise have a harmful environment impact.

The aggregate particles described herein are advantageously designed to fit these goals. Once the aggregate particles are mixed with cement, water, and other materials to form a concrete product, the particles are mechanically and chemically fixed in the concrete. Thus, no physical force can disassociate it from the hardened cement. This fixing characteristic is what eliminates the common concern of micro-plastic shedding and loss. Further, the limestone casing shown in FIG. 6 advantageously bonds with the cement in concrete and may form a stronger bond that the preconditioned resin aggregate particles alone. Thus, the hybrid aggregate becomes permanently sequestered in a concrete product and building project for the entire life cycle of that building. When the building is deconstructed, the concrete and the aggregates described herein, namely preconditioned resin aggregate and/or hybrid aggregate, will be crushed into rubble and utilized once again as construction aggregate. As such, embodiments of the devices, systems, and methods herein provide a complete and long-term circular solution to plastic waste and concrete products. These same benefits, as well as others, can be achieved with the FRHA particles described above.

Providing such an environmentally benign resin aggregate or hybrid aggregate that can be safely and efficiently transported and that exhibits such unique industrial crossover characteristics could lead to a waste management paradigm shift and the effective recovery and repurposing of mixed plastic wastes, including “tragic” plastics, which are unnecessarily filling landfills and fouling the environment.

Although the systems and methods described herein are often discussed in the context of producing aggregates for use in concrete products or as a feedstock for liquid fuel pyrolysis, it is appreciated that such aggregates and related waste plastics feedstock may be used for a wide variety of other purposes.

Moreover, aspects and features of the various embodiments described above may be combined to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A method of making a particle, the method comprising:
obtaining a supply of granulated mixed plastic waste treated with a preconditioning agent to improve sanitation of the granulated mixed plastic waste;
extruding the granulated mixed plastic waste to form an extruded product including waste plastic material;
processing the extruded product to form a particle in which the waste plastic material is exposed at exterior surfaces thereof;
after the processing, battering the particle with a calcium hydroxide or calcium oxide-based powder to form a preconditioned particle; and
passing the preconditioned particle through a reactor to interact the calcium hydroxide or calcium oxide-based powder with flue gases in the reactor and form a hybrid particle with a calcium carbonate layer on the waste plastic material.

2. The method of claim 1 wherein the supply of granulated mixed plastic waste includes a variety of plastic materials including at least one of high density polyethylene, polypropylene, PVC, ABS, polyurethane, polyamide, and PET, or wherein a portion of the supply of granulated mixed plastic waste includes non-plastic material.

3. The method of claim 1, further comprising, after passing the preconditioned particle through the reactor:
washing the hybrid particle in a calcium hydroxide bath; and
drying the hybrid particle.

4. The method of claim 1 further comprising, before extruding the granulated mixed plastic waste:
batching the preconditioned granulated mixed waste plastic by density.

5. The method of claim 1, wherein the preconditioning agent is at least one of calcium hydroxide and ash.

6. The method of claim 1, wherein the supply of granulated mixed plastic waste treated by the preconditioning agent includes at least about 50% waste plastic material by weight.

7. The method of claim 1, wherein passing the preconditioned particle through the reactor includes capturing carbon dioxide from the flue gases in the calcium carbonate layer.

8. The method of claim 7, wherein capturing carbon dioxide includes capturing carbon dioxide in an amount up to 50% by weight of the hybrid particle.

9. The method of claim 1, further comprising, after obtaining the supply of granulated mixed plastic:
mixing the supply of granulated mixed plastic waste treated with the preconditioning agent with one or more additives to form a plastic waste mixture.

10. The method of claim 9 wherein the one or more additives includes at least one of an essence, a fire retardant, pozzolans, and an anti-bacterial agent.

11. The method of claim 1, wherein extruding the granulated mixed plastic waste to form the extruded product includes hot extruding the granulated mixed waste plastic material at a processing temperature between about 165° C. and about 230° C.

12. A device, comprising:
a particle including granulated mixed plastic waste treated with a preconditioning agent having waste plastic material exposed at exterior surfaces thereof; and
a calcium carbonate layer on the particle, the calcium carbonate layer disposed on the waste plastic material exposed at the exterior surfaces of the particle to form a coated particle,
wherein the calcium carbonate layer includes captured carbon dioxide, and
wherein, during formation of the coated particle, the particle has an electrostatic charge that assists with formation of the calcium carbonate layer.

13. The device of claim 12 wherein the preconditioning agent is at least one of calcium hydroxide and ash.

14. The device of claim 12, further comprising:
an additive applied to the granulated mixed plastic waste, wherein the additive includes at least one of an essence, a fire retardant, pozzolans, and an anti-bacterial agent.

15. A concrete product including the device of claim 12.

16. A method of making a particle, the method comprising:
obtaining a supply of granulated mixed plastic waste;
extruding the granulated mixed plastic waste to form an extruded product including waste plastic material;
processing the extruded product to form a particle in which the waste plastic material is exposed at exterior surfaces thereof;
creating an electrostatic charge on the particle;
battering the particle with a calcium hydroxide or calcium oxide-based paste to form a preconditioned particle, wherein the electrostatic charge on the particle assists with covering the particle with the calcium hydroxide or calcium oxide-based paste; and
passing the preconditioned particle through a reactor to interact the calcium hydroxide or calcium oxide-based paste with flue gases in the reactor and form a calcium carbonate layer on the waste plastic material.

17. The method of claim 16 wherein the supply of granulated mixed plastic waste includes a variety of plastic materials including at least one of high density polyethylene, polypropylene, PVC, ABS, polyurethane, polyamide, and PET, or wherein the supply of granulated mixed plastic waste includes non-plastic material.

18. The method of claim 16, wherein the supply of granulated mixed plastic waste includes at least about 50% waste plastic material by weight.

19. The method of claim 16, wherein passing the preconditioned particle through the reactor includes capturing carbon dioxide from the flue gases in the calcium carbonate layer.

20. The method of claim 19 wherein capturing carbon dioxide includes capturing carbon dioxide in an amount up to 50% by weight of the hybrid particle.

21. The method of claim 16, further comprising, after obtaining the supply of granulated mixed plastic:
mixing the supply of granulated mixed plastic waste with one or more additives to form a plastic waste mixture.

22. The method of claim 16, wherein extruding the granulated mixed plastic waste includes hot extruding at a processing temperature between about 165° C. and about 230° C.

23. (canceled)

24. The method of claim 16, wherein the electrostatic charge on the particle is a negative electrostatic charge.

25. The method of claim 16, wherein creating the electrostatic charge includes triboelectric charging.

26. The method of claim 16, wherein passing the preconditioned particle through the reactor includes capturing carbon dioxide from the flue gases in the calcium hydroxide or calcium oxide-based paste and resulting calcium carbonate layer on the waste plastic material.

27. A device, comprising:
a particle including granulated mixed plastic waste having waste plastic material exposed at exterior surfaces thereof, wherein during formation, the particle has a negative electrostatic charge; and
a calcium carbonate layer on the particle, the calcium carbonate layer disposed on the waste plastic material exposed at exterior surfaces of the particle, aggregate,
wherein the calcium carbonate layer includes captured carbon dioxide.

28. The device of claim 27, wherein the particle is sand formed of waste plastic material.

29. The device of claim 27, wherein the carbon dioxide is present in the calcium carbonate layer in an amount up to 50% by a weight of a combination of the particle and the calcium carbonate layer.

30. A concrete product including the device of claim 27.
